(19) United States
(12) Patent Application Publication
(10) Pub. No.: US 2024/0151841 A1
(43) Pub. Date: May 9, 2024

(54) METHOD FOR DETECTING A SPECIFIED MOVEMENT PATTERN, ULTRA WIDE-BAND SENSOR DEVICE, AND VEHICLE COMPRISING AN ULTRA WIDE-BAND SENSOR DEVICE

(71) Applicant: Continental Automotive Technologies GmbH, Hannover (DE)

(72) Inventors: Lars Weisgerber, Regensburg (DE); Mario Schuehler, Effeltrich (DE); Thomas Eichstetter, Weiherhammer (DE); Christian Schneider, Lappersdorf (DE)

(73) Assignee: Continental Automotive Technologies GmbH, Hannover (DE)

(21) Appl. No.: 18/280,142

(22) PCT Filed: Feb. 23, 2022
(86) PCT No.: PCT/DE2022/200026

§ 371 Date: Sep. 1, 2023

(30) Foreign Application Priority Data
Mar. 2, 2021 (DE) 10 2021 201 967.6

(51) Int. Cl. G01S 13/02; G01S 7/41; G01S 13/46; G01S 13/76; G01S 13/87; G01S 13/88

(52) U.S. Cl. CPC G01S 13/0209; G01S 7/415; G01S 13/46; G01S 13/76; G01S 13/872; G01S 13/878; G01S 13/88

(57) ABSTRACT

An ultra-wideband sensor transmits impulse radio signals over a predetermined time period, detects echo signals of the impulse radio signals by way of at least one sensor of the ultra-wideband sensor and generates a time-variant channel impulse response that describes the echo signals received by the at least one sensor as a function of a time at which the respective impulse radio signal of the predetermined time period was transmitted and a path delay, uses a predetermined selection method to ascertain at least one ascertained path delay, generates a signal characteristic of the time-variant channel impulse response for the at least one ascertained path delay, uses a predetermined comparison method to determine a similarity of the signal characteristic to a reference characteristic, and detects a predetermined movement pattern associated with the reference characteristic if the similarity meets a predetermined similarity criterion.

The invention relates to a method for recognizing a predetermined movement pattern, an ultra-wideband sensor device and a vehicle that comprises an ultra-wideband sensor device.

The automotive sector is currently undergoing major changes towards electromobility and connectivity. In the future, vehicles and users will be constantly connected to one another, vehicles will intuitively know what the user needs, and the vehicle will be able to respond and accordingly adapt to the user's needs and the changing surroundings and conditions. In the near future, vehicles will be constantly networked to one another and will continually monitor their surroundings.

Observing and capturing the surroundings of the vehicle and a state of the vehicle itself will be a complex operation that will be required prior to an autonomous analysis and reaction process. In the future, the vehicle will decide what information is relevant and important to the driver and will provide this information to the driver for assistance. The vehicle will also undertake complex tasks to relieve and protect the driver.

In order to provide intelligent services such as these, a large number of problems need to be solved. The handling and processing of the large volumes of data and the information they provide is a complex topic. The first step in facilitating the intelligent services is the provision of meaningful data by reliable sensor units of the vehicle. This point is one of the biggest challenges in the entire service chain. It is necessary to clarify which sensor unit is useful and necessary for providing a function, and whether the sensor units are fully integrated and cost-effective. A sensor unit may perform different tasks. Sensor units can merge in order to set up necessary redundancy and/or to reduce unnecessary redundancy. In order to be able to use a sensor unit for different tasks, however, specific data processing routines are required.

A part of the vehicle sensor system is provided to detect movements in the vehicle interior or in the surroundings of the vehicle. According to the current prior art, the sensor units used for this are capacitive, radar-, ultrasound-, laser- or camera-based.

One area of application for motion detection sensors are systems for automatically unlocking the trunk and/or opening the trunk. These detect a predetermined movement pattern, such as a kick from a person, in order to unlock and/or open the trunk when predetermined conditions exist. Multiple problems arise when using the typical capacitive sensor units, radar-based sensor units or ultrasonic sensors. On the one hand, a specific motion detection method is required in order to be able to identify the kick in the sensor data. A second problem is the occurrence of erroneous kick detection, which can occur for example if animals such as cats or dogs are situated behind or under the vehicle. A movement pattern of this animal can be mistakenly identified as a kick and lead to the trunk being opened. Another problem arises if a sensor unit is covered by dirt or snow. In this case, motion detection is limited or even impossible. This problem occurs in particular with capacitive or camera-based sensor units.

An alternative to providing additional sensor units for motion detection is to use sensor units that are already present. The ultra-wideband sensor system of a vehicle is particularly suitable for this. The recent integration of ultra-wideband location technology in smart access and relay attack defense services will provide a new type of technology for the automotive sector that, besides precise determination of a signal propagation time between the sensor units and an ultra-wideband key, additionally provides a simple radar functionality. Ultra-wideband systems are primarily designed to determine the range and position of the user's ultra-wideband digital key. For this purpose, the vehicle is equipped with multiple wideband communication transceivers (responders) in different positions, for example in the interior or outside, which actively locate the digital ultra-wideband key by communicating with at least one wideband counterpart transceiver (initiator) in the digital ultra-wideband key in order to use the signal propagation time to determine the distance between the initiator and the responder. By determining the distances between the initiator and the individual responders, the position of the digital ultra-wideband key can be computed using trilateration. The ultra-wideband sensor system covers a bandwidth of at least 500 MHz, for example.

The channel impulse response is used in the known key locating methods to determine the signal propagation time on the two sides (initiator, responder). This means that the basis for a passive evaluation of a spatial channel impulse response already exists. In this case, an impulse radio signal transmitted by a sensor unit can be correlated with the reflected echo signal detected by the sensor unit, without an active counterpart being necessary. The continuous repetition of a transmission-reception correlation process allows spatial changes such as predetermined movement patterns, for example a kick or a respiratory movement by a person, to be detected.

The problem with using these methods is that the spatial resolution of the ultra-wideband systems used in vehicles is not sufficient to detect certain, smaller changes in the distances between an object and a sensor unit, such as occur when the chest moves during respiration. In addition, a noise response of the sensor unit may cause so-called pseudo-patterns similar to those of the predetermined movement patterns to occur in the channel impulse response. This can lead to the sensor system recognizing a predetermined movement pattern erroneously, as a result of which the vehicle unintentionally carries out a predetermined action associated with the predetermined movement pattern.

In addition, there can be provision for the predetermined actions to be able to be initiated only in specific local detection areas in relation to the vehicle and/or by specific people. If the predetermined movement pattern is carried out accidentally or intentionally by unauthorized passers-by, this can also lead to unwanted performance of the predetermined action. Owing to these disadvantages, the reliability of movement pattern recognition by means of ultra-wideband sensors can be impaired.

It is an object of the invention to provide a method that facilitates reliable recognition of predetermined movement patterns by means of ultra-wideband sensors.

The basic idea of the invention is that ultra-wideband sensors are used to measure a distance of a movement in order to use a change in a phase and/or amplitude to recognize a movement pattern.

The invention relates to a method for recognizing a predetermined movement pattern. There is provision for an ultra-wideband sensor device to transmit impulse radio signals over a predetermined time period. Echo signals of the impulse radio signals are detected by way of at least one sensor unit of the ultra-wideband sensor device and a time-variant channel impulse response h(τ,t) is generated that describes the echo signals received by the at least one sensor unit as a function of a time t at which the respective impulse radio signal was transmitted over the predetermined time period and a path delay τ. The path delay τ describes a time between the transmission of an impulse radio signal and the reception of the associated echo signal. The path delay is also referred to as fast time. The time t describes a time referred to as slow time, which indicates the transmission time of the respective impulse radio signal. The echo signal refers not only to a single impulse, but rather, for example, to an echo signal that is received continuously over a predetermined time period of the path delay τ and that can comprise multiple different reflections of the impulse radio signal that have been reflected from different objects and are detected by the sensor unit for different path delays τ.

A predetermined selection method is used to ascertain at least one ascertained path delay τP. This can be accomplished, for example, by a scatter function or time-variant scatter function of the time-variant channel impulse response, in which changes in the time-variant scatter function can be recorded as a respective local maximum. The respective local maximum can be characterized by a respective Doppler frequency and a respective path delay. These local maxima can be due to movements. The at least one ascertained path delay τP of at least one of the local maxima can therefore be selected to identify the predetermined movement pattern. This may make it possible to evaluate the time-variant channel impulse response for the at least one ascertained path delay τP in order to establish whether the respective change in the time-variant channel impulse response for the at least one ascertained path delay τP is a movement that has the predetermined movement pattern. The at least one ascertained path delay τP can be referred to as a multiple of a step value τ0 with an index P. The ascertained path delay τP=P τ0 is also referred to as a bin or tap in technical terminology.

For the at least one ascertained path delay τP, a signal characteristic (ϕ(t)) is generated from the time-variant channel impulse response (h(t, τ)) for the at least one ascertained path delay τP. The signal characteristic φ(t) can describe a characteristic of a phase, frequency or amplitude, for example. In other words, the time-variant channel impulse response h(t, τ=τP) is generated for the at least one ascertained path delay τP. From this, the respective signal characteristic φ(t) over the time t is produced for the at least one ascertained path delay τP.

A predetermined comparison method is used to compute a similarity of the signal characteristic φ(t) for the at least one ascertained path delay τP to a reference characteristic φ0(t). The reference characteristic φ0(t) can indicate a predetermined characteristic of the phase, frequency or amplitude over the time t, associated with the predetermined movement pattern. The predetermined movement pattern is found to exist if the similarity ascertained using the comparison method meets a predetermined similarity criterion. There can be provision for the comparison method to comprise determining the similarity by means of a predetermined similarity function that determines a degree of correspondence between the reference characteristic φ0(t) and the computed signal characteristic φ(t). The reference characteristic φ0(t) can describe both a characteristic predefined signal characteristic φ(t) of a predetermined periodic movement and that of a non-periodic movement. The similarity criterion predefined may be the exceeding of a predefined similarity threshold of a similarity value. In other words, the at least one predetermined movement pattern can be recognized for example when the similarity function ascertains the similarity value that exceeds the predefined similarity threshold, which rates the similarity of the reference characteristic φ0(t) to the signal characteristic φ(t). Multiple predetermined movement patterns can be predefined, which can have respective associated reference characteristics φ0(t). The predetermined movement patterns can include, for example, predetermined kicking movements, stepping movements or hand gestures.

One development of the invention provides for the ultra-wideband sensor device to detect the predetermined movement pattern only if the respective signal characteristics φ(t) of at least two sensor units meet the predetermined similarity criterion. In other words, there is provision for the predetermined movement pattern to be detected by the ultra-wideband sensor device only if at least two signal characteristics φ(t) of respective sensor units have the predetermined similarity to the respective reference characteristic φ0(t). The similarity criterion can be met at an identical time t or within a predetermined time period with respect to t. In other words, the predetermined movement pattern must be recognized in at least two signal characteristics φ(t) of different sensor units. The development results in the advantage that erroneous detections of the predetermined movement patterns, which can be caused by noise in the signal characteristic φ(t) of a single sensor unit, for example, are reduced. For example, the signal characteristic ϕ(t) of one of the sensor units may exhibit a certain noise response that results in the signal characteristic ϕ(t) coincidentally meeting the predetermined similarity criterion with regard to the reference characteristic ϕ0(t) and thus in the predetermined movement pattern being recognized for the signal characteristic ϕ(t) erroneously. However, it may be that the reference characteristic ϕ0(t) is not recognized in the signal characteristic ϕ(t) of another sensor unit. The predetermined movement pattern is therefore not recognized by the ultra-wideband sensor device, comprising the sensor units and the evaluation unit, because the reference characteristic φ0(t) cannot be verified by the further signal characteristic φ(t) of another of the sensor units.

One development of the invention provides for the ultra-wideband sensor device to determine a locality of the predetermined movement pattern from the at least one ascertained path delay τP using a predetermined locating method. In other words, the ultra-wideband sensor device is configured to evaluate at least one ascertained path delay τP, or multiple path delays τP ascertained by respective sensor units, in whose signal characteristics ϕ(t) of the sensor units the predetermined movement pattern is recognized, in order to ascertain the locality at which the predetermined movement pattern has occurred. There can be provision, for example, for echo signals due to a specific impulse radio signal to be detected by at least two of the sensor units with respective ascertained path delays τP. As the sensor units can be arranged at different places on a vehicle, the distances of the respective sensor units from the locality of the predetermined movement pattern from which the echo signals have been reflected can differ. The different distances mean that the path delays τPa, τPb associated with the predetermined movement pattern that are ascertained by the sensor units can differ from one another. Knowledge of the two ascertained path delays τPa, τPb allows the origin of the predetermined movement pattern to be determined by means of trilateration methods.

One development of the invention provides for a predetermined control signal to be transmitted by the ultra-wideband sensor device only if the locality of the predetermined movement pattern is localized in a predetermined local detection area. In other words, the at least one detection area is locally predefined and a predetermined position of the at least one predetermined detection area with respect to the vehicle is stored in the ultra-wideband sensor device. There is provision for the ultra-wideband sensor device to output the predetermined control signal only if the predetermined movement pattern has occurred within the predetermined local detection area. There can be provision for the ultra-wideband sensor device to transmit a predetermined control signal if the locating method establishes that the predetermined movement pattern occurs within the predetermined local detection area. This results in the advantage that predetermined actions can be initiated on condition that the predetermined movement pattern occurs only in the delimited detection area. There can be provision, for example, for a trunk to be unlocked and/or opened upon reception of the control signal if a stepping movement is detected as the predetermined movement pattern in the predetermined detection area, which can be localized in front of the trunk of the vehicle. This results in the advantage that a predetermined action is initiated only if the movement occurs in a specific local area. This can reduce the probability of, for example, the opening and/or unlocking of the trunk or some other action being unintentionally initiated.

One development of the invention provides for the impulse radio signal to be transmitted by a different sensor unit than the sensor unit that receives the reflected echo signal. In other words, one of the sensor units acts only as a transmitter for transmitting the impulse radio signal and not as a receiver of the associated echo signal. The echo signal is received by at least one sensor unit, which acts only as a receiver.

One development of the invention provides for the ultra-wideband sensor device to use an active locating method to detect a position of an ultra-wideband key, and to specify the predetermined detection area on the basis of the locality of the ultra-wideband key using a predetermined specification method. The ultra-wideband sensor device combines the active locating method for locating the ultra-wideband key, which facilitates relatively accurate location, with the described passive locating method for detecting the predetermined movement patterns. The ultra-wideband key can be, for example, a uniquely identifiable ultra-wideband key of a driver of the vehicle that is coupled to the ultra-wideband sensor device. In other words, there can be provision for the position of the predetermined detection area to depend on the key position at which the ultra-wideband key is located. The precise specification of the position of the detection area by the ultra-wideband sensor device can be predefined by the specification method. For example, the predetermined detection area may be predefined as being restricted by a predefined radius around the key position of the ultra-wideband key. This can allow the predetermined movement pattern to result in a transmission of the control signal only if it occurs in proximity to the located ultra-wideband key and thus within the detection area. Assuming that the ultra-wideband key is carried only by the driver, the vehicle owner of the vehicle or an authorized person in general, this can indirectly allow only predetermined movement patterns carried out by the driver, the vehicle owner of the vehicle or an authorized person in general to result in a transmission of the control signal and thus in the initiation of the predetermined action. This can prevent predetermined movement patterns carried out by an unauthorized person in the vicinity of the vehicle from resulting in a transmission of the control signal. The predetermined specification method can additionally specify the position of the detection area on the basis of other local parameters. The detection area can be predefined, for example, by an intersection of a predetermined area in relation to the vehicle and a predetermined area around the locality of the ultra-wideband key. This allows the detection area to be restricted to a local area that is specified in front of a trunk of the vehicle, for example, and at the same time is restricted to a predetermined area close to the ultra-wideband key.

One development of the invention provides for the signal characteristic (φ(t)) to be a phase characteristic of the complex channel impulse response. In other words, the characteristic of the phase of the complex channel impulse response is determined for the at least one ascertained path delay τP.

One development of the invention provides for the predetermined control signal to be received by the vehicle, and for reception of the predetermined control signal by the vehicle or a control unit of the vehicle to result in a trunk of the vehicle being unlocked and/or opened. In other words, there is provision for the trunk to be unlocked and/or opened when said control unit receives the predetermined control signal. This results in the advantage that the trunk can be unlocked and/or opened by carrying out the predetermined movement pattern. It is therefore not necessary to operate a button on the ultra-wideband key to unlock and/or open the trunk.

One development of the invention provides for the predetermined comparison method for determining the similarity of the signal characteristic φ(t) to the reference characteristic φ0(t) to comprise determining a Euclidean distance between the signal characteristic φ(t) and the reference characteristic φ0(t).

The invention also comprises an ultra-wideband sensor device for recognizing a predetermined movement pattern. The ultra-wideband sensor device is configured to transmit impulse radio signals over a predetermined time period and to detect echo signals of the impulse radio signals by way of at least one sensor unit of the ultra-wideband sensor device and to generate a time-variant channel impulse response h(t, τ) that describes the echo signals received by the at least one sensor unit as a function of a time t at which the respective impulse radio signal was transmitted in the predetermined time period and a path delay τ. The ultra-wideband sensor device is configured to use a predetermined selection method to ascertain at least one ascertained path delay τP and to generate a signal characteristic φ(t) of the time-variant channel impulse response h(t, τ) for the at least one ascertained path delay τP. The ultra-wideband sensor device is configured to use a predetermined comparison method to determine a similarity of the signal characteristic φ(t) to a reference characteristic φ0(t), and to detect a predetermined movement pattern associated with the reference characteristic φ0(t) if the similarity meets a predetermined similarity criterion.

The invention also comprises a vehicle with an ultra-wideband sensor device. The vehicle can be configured in particular as a passenger vehicle or truck. There can be provision for the vehicle to be configured to perform predetermined actions as soon as predetermined movement patterns are detected by the ultra-wideband sensor device.

The invention also includes developments of the ultra-wideband sensor device according to the invention and of the vehicle according to the invention that have features such as have already been described in connection with the developments of the method according to the invention. For this reason, the corresponding developments of the ultra-wideband sensor device according to the invention and of the vehicle according to the invention are not described again here.

The invention also comprises the combinations of the features of the described embodiments.

An exemplary embodiment of the invention is described below, in which regard:

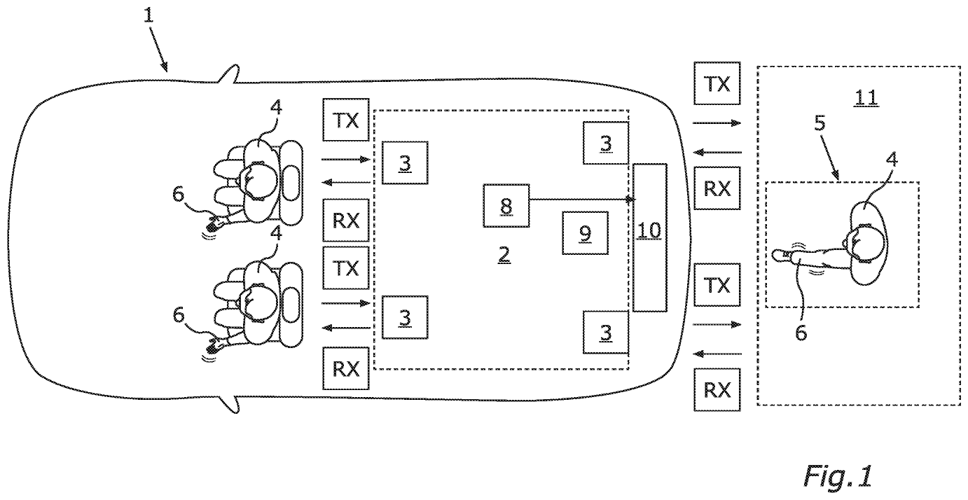

FIG. 1 shows a vehicle that has an ultra-wideband sensor device;

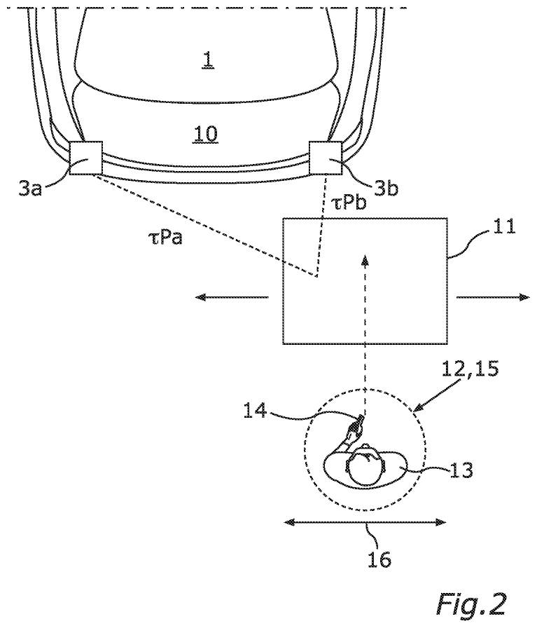

FIG. 2 shows a detection area being matched to the location of a driver;

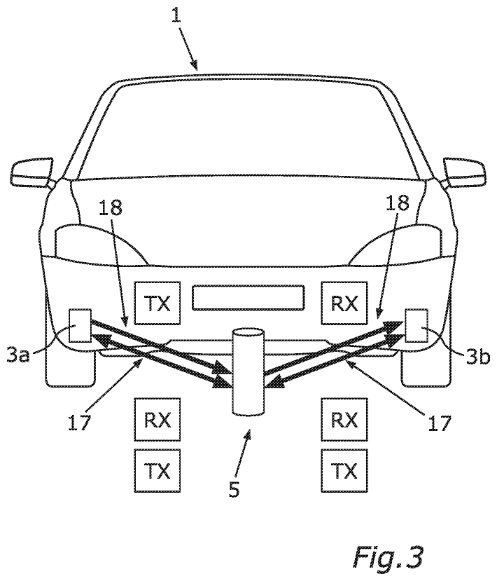

FIG. 3 shows two possible methods for operating an ultra-wideband sensor device;

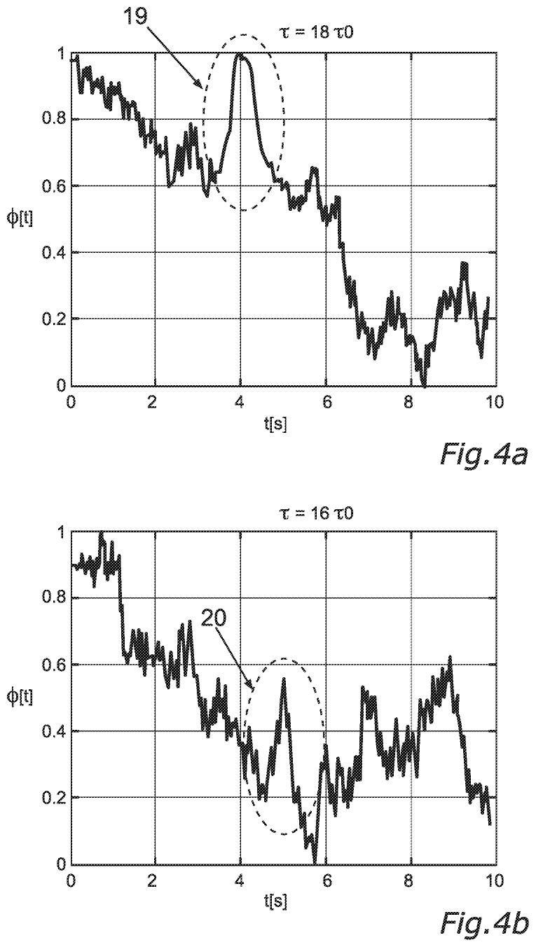

FIG. 4a shows a possible signal characteristic φ(t) for a phase of a complex channel impulse response;

FIG. 4b shows a possible signal characteristic φ(t) for a phase of a complex channel impulse response;

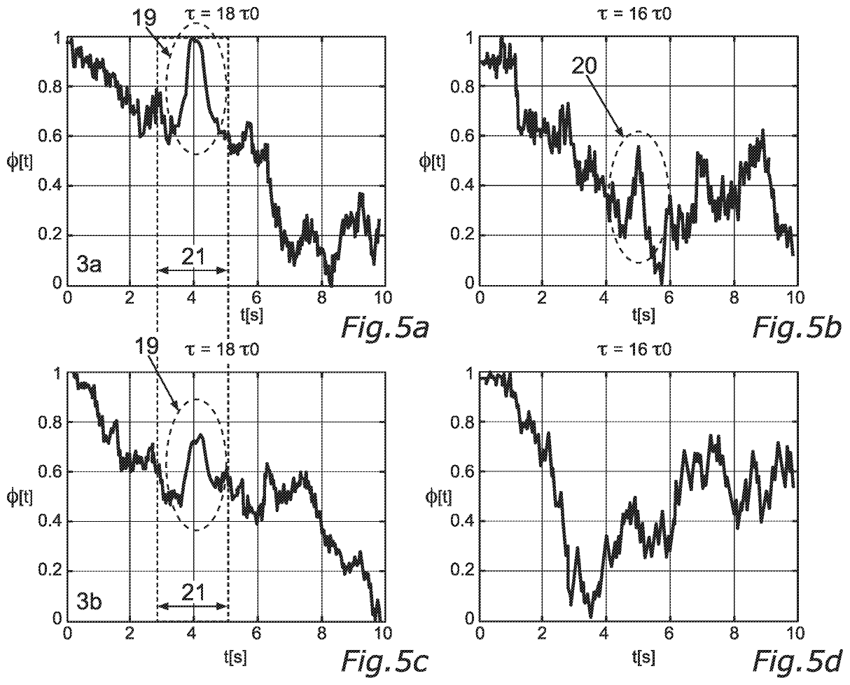

FIG. 5a shows a possible signal characteristic φ(t) for a phase of a complex channel impulse response;

FIG. 5b shows a possible signal characteristic φ(t) for a phase of a complex channel impulse response;

FIG. 5c shows a possible signal characteristic φ(t) for a phase of a complex channel impulse response;

FIG. 5d shows a possible signal characteristic φ(t) for a phase of a complex channel impulse response;

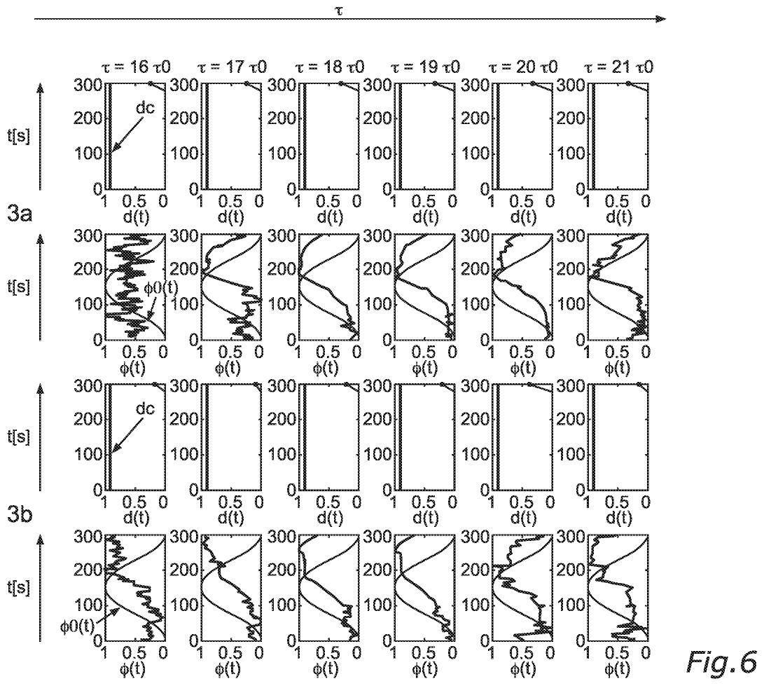

FIG. 6 shows respective signal characteristics φ(t) of two sensor units;

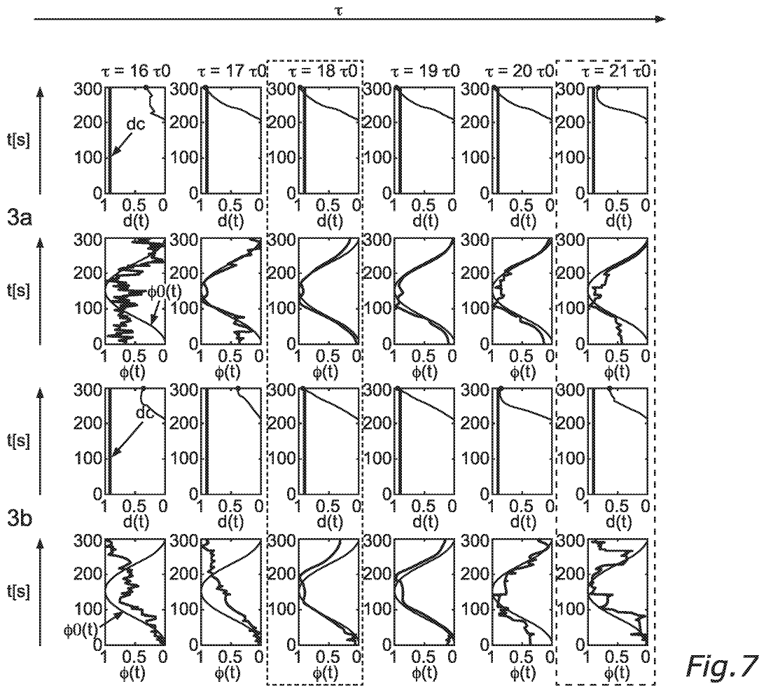

FIG. 7 shows respective signal characteristics φ(t) of two sensor units;

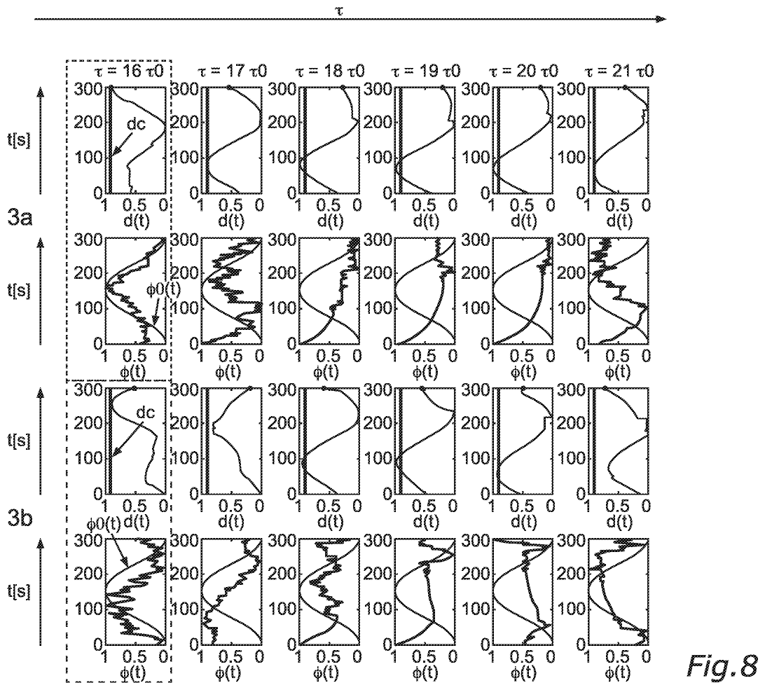

FIG. 8 shows respective signal characteristics φ(t) of two sensor units;

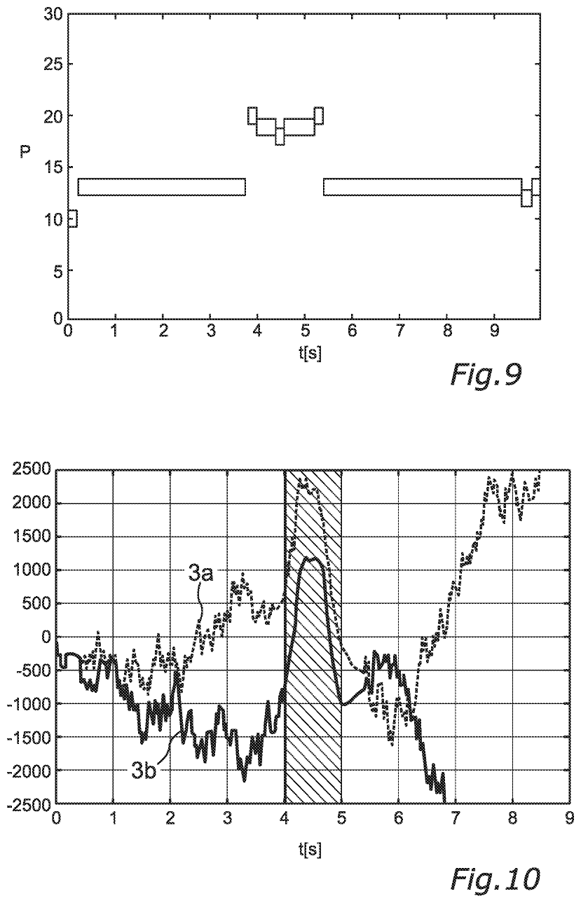

FIG. 9 shows a mask for combining multiple signal characteristics φ(t);

FIG. 10 shows composite signal characteristics φ(t).

The exemplary embodiment explained below is a preferred embodiment of the invention. In the exemplary embodiment, the described components of the embodiment each represent individual features of the invention that should be considered independently of one another and that each also develop the invention independently of one another and can therefore also be considered to be part of the invention individually or in a combination other than that shown. Furthermore, the embodiment described can also be supplemented by further features of the invention that have already been described.

In the figures, elements with the same function are each provided with the same reference signs.

FIG. 1 shows a vehicle 1 that has an ultra-wideband sensor device 2. The ultra-wideband sensor device 2 can have at least two sensor units 3, these being able to be ultra-wideband sensors that can be configured as transceivers. As a result, they can be suitable for transmitting impulse radio signals TX and receiving echo signals RX that are reflections of the impulse radio signals TX. The sensor units 3 can be configured to successively transmit the impulse radio signals TX repeatedly, at constant or non-constant intervals of time. The sensor units 3 can receive the reflected echo signals RX, which have been reflected from objects 4 in the surroundings. The echo signals RX due to an impulse radio signal TX transmitted at a time t can be characterized by the ultra-wideband sensor device 2 in a respective channel impulse response h(τ). The channel impulse response h(τ) can, for example, describe a characteristic of an amplitude of the respective echo signal RX as a function of the path delay τ since the time t at which the impulse radio signal TX was transmitted. The channel impulse response h(τ) can also be defined as a complex channel impulse response. The path delay τ depends on a distance of the object 4 from which the impulse radio signal TX was reflected as an echo signal RX from the sensor unit 3. This can allow the distance of an object 4 from a respective sensor unit 3 to be determined. If an impulse radio signal TX is reflected from the object 4 and the reflected echo signals RX are detected by at least two of the sensor units 3, the respective path delays τ detected at the sensor units 3 can be used to determine respective distances of the sensor units 3 from the object 4. This allows predetermined locating methods, such as trilateration methods, to be used to determine a locality 5 of the object 4 from which the impulse radio signal TX has been reflected.

There can be provision for the ultra-wideband sensor device 2 to be configured to detect predetermined movement patterns 6. This can be done, for example, by evaluating a signal characteristic φ(t) of the echo signal RX over the time t for at least one ascertained path delay τP. For this purpose, the individual channel impulse responses h(τ), which are associated with the consecutive times t, can be combined to produce a time-variant channel impulse response h(t, τ) that describes the response not only as a function of the path delay τ but also as a function of the time t. A movement causes a change in the time-variant channel impulse response h(t, τ) over time that can be seen as a time-variant component in the time-variant channel impulse response h(t, τ).

The Doppler shift that occurs during the movement can be used to identify the movement in the time-variant channel impulse response h(t, τ). This can be accomplished by transforming individual time windows of the time-variant channel impulse response h(t, τ) into respective scatter functions hs(v, τ). Changes over time, such as movements, can be recognized in said scatter functions as local maxima, characterized by a Doppler frequency v and a respective path delay τ. Using the scatter function hs(v, τ), a predetermined selection method can be used to determine at least one ascertained path delay τP, which can be associated with a local maximum P in the scatter function hs(v, τ) and thus with the associated movement, and which can be used to ascertain a distance of the locality 5 of the object 4 associated with the movement from the respective sensor unit 3. If the movement is over a relatively small local area compared with the resolving power of the sensor unit 3, an identical ascertained path delay τP can be ascertained for all time windows. In the case of relatively large movements, the ascertained path delays τP, which have been ascertained for a local maximum P in different time windows, can differ from one another. In this case, multiple ascertained path delays τP can be selected by the predetermined selection method for further evaluation of the time-variant channel impulse response h(t, τ). The further evaluation of the movement, in particular identification of one of the predetermined movement patterns 6, can be carried out by evaluating a signal characteristic φ(t) that is generated from the time-variant channel impulse response h(t, τ) for the at least one ascertained path delay τP. For this purpose, the time-variant channel impulse response h(t, τ) for the at least one ascertained path delay τP can be used for example to ascertain a signal characteristic φ(t) of a frequency and/or phase and/or amplitude over the time t. This can allow phase changes between successive echo signals RX to be identified, for example. The phase change can take place as a result of movements of the object 4 that reflects successive impulse radio signals TX. Due to the movement of the object 4, the locality 5 and thus the distance of the object 4 from the sensor unit 3 can change. The change in the distance can also result in a phase angle of the successive echo signals RX detected by this sensor unit 3 changing over the time t. Depending on the type of movement, characteristic patterns 19 may be identifiable in the signal characteristic φ(t). As a result, it may be possible to distinguish individual movements from one another and to identify the predetermined movement patterns 6, the characteristic patterns 19 of which may be defined in a respective reference characteristic φ0(t). The reference characteristic φ0(t) can indicate a predetermined characteristic of the amplitude and/or phase and/or frequency over the time t that is associated with the predetermined movement pattern 6. The predetermined movement pattern 6 can be recognized by the ultra-wideband sensor device 2 by virtue of a similarity between the signal characteristic φ(t) and the reference characteristic φ0(t), ascertained in a predetermined comparison method, meeting a predetermined similarity criterion. The comparison method can comprise computing a similarity value d(t) by means of a predetermined similarity function. The similarity criterion can be met, for example, as soon as the similarity value d(t) exceeds a predetermined threshold dc. The comparison method and/or the similarity criterion can depend on the predetermined movement pattern 6. The ultra-wideband sensor device 2 can have a control unit 8 for carrying out the individual methods. Said control unit can have a microprocessor and/or a microcontroller.

There can be provision for the detection of the predetermined movement patterns 6 to result in a predetermined control signal 9 being output by the ultra-wideband sensor device 2 in order to activate predetermined functions in the vehicle 1 or to initiate predetermined actions in the vehicle 1. The predetermined action can be, for example, opening and/or unlocking of a trunk 10 of the vehicle 1. There can be provision for the predetermined movement pattern 6 to be detected by the ultra-wideband sensor device 2 only if it has been identified in the respective signal characteristics φ(t) of at least two of the sensor units 3. This allows a probability of erroneous detections of movement, for example due to a noise response or movements of animals or plants, to be reduced. There can be provision for the control signal 9 to be transmitted only if the predetermined movement pattern 6 is detected in a predetermined detection area 11. Said detection area can be predefined locally in relation to the vehicle 1, for example. The predetermined detection area 11 can be, for example, a locally delimited area in front of the trunk 10 of the vehicle 1. This results in the advantage that the probability of erroneously initiated actions can be minimized.

The path delay τ of the complex channel impulse response corresponds, for example, to a specific distance between the locality of the movement 4, for example a human kick, and the sensor unit 3 that received the echo signal RX reflected by the leg that performed the kick. Since a kick or a similar movement causes a time-variable component in the time-variant channel impulse response h(t,τ), the at least one ascertained path delay τP can be identified, for which there is a Doppler frequency shift in the echo signal RX. It is assumed below that the at least one ascertained path delay τP of the movement has already been selected. In a next step, a signal characteristic φ(t), such as a signal characteristic φ(t) of a phase and/or frequency and/or amplitude for example, needs to be analyzed in order to decide whether the movement is the predetermined movement pattern 6.

This can be accomplished using the predetermined comparison method, allowing a similarity of the signal characteristic φ(t) to the reference characteristic φ0(t) to be determined. The reference characteristic φ0(t) can describe the characteristic pattern 19, which can be observed in the signal characteristic φ(t) in the case of the predetermined movement pattern 6.

FIG. 2 shows the detection area 11 being matched to the location 12 of a key carrier 13 of a predetermined ultra-wideband key 14 that is approaching the rear of the vehicle 1. There can preferably be provision for the predetermined detection area 11 to change on the basis of a location 12 at which the key carrier 13, for example the vehicle owner of the vehicle 1, is situated. This can be achieved, for example, as a result of the predetermined ultra-wideband key 14 being actively located by the ultra-wideband sensor device 2 concurrently with the passive movement detection described. This can be accomplished, for example, by using predetermined active locating methods, as are customary in the case of ultra-wideband sensor devices 2 according to the prior art. The location 12 of the key carrier 13 can thus be determined by actively locating his ultra-wideband key 14 by way of the ultra-wideband sensor device 2. Any lateral displacement 16 of the key carrier 13 with respect to the vehicle 1 can result in the detection area 11 being accordingly matched using a predetermined specification method. Synchronizing the sensor units 3a, 3b located on the left (3a) or right (3b) bumper of the vehicle 1, for example, allows them to operate as a distributed radar. It is thus possible to use the fact that the key carrier 13 carries the ultra-wideband key 14 with him and a key position 15 therefore corresponds to the location 12 of the key carrier 13. There can be provision for the predetermined detection area 11 to be delimited by a predetermined radius, which is situated around the ascertained key position 15. This results in the advantage that only predetermined movement patterns 6 of the key carrier 13 result in the control signal 9 being transmitted in practice.

The occurrence of the predetermined movement pattern 6 within the predetermined detection area 11 can be detected, for example, as a result of the path delays τPa, τPb, which are detected by the sensor units 3a, 3b for the predetermined movement pattern 6, being in a predetermined value range.

FIG. 3 shows two possible methods for operating the ultra-wideband sensor device 2. In a first passive operating mode of the ultra-wideband sensor device 2, the sensor units 3a, 3b can be used both for transmitting the impulse radio signal TX and for receiving the echo signal RX, as shown by the arrows 17. In a distributed operating mode of the ultra-wideband sensor device 2, it can use one of the sensor units 3a only as a transmitter of the impulse radio signal TX and another one of the sensor units 3b only as a receiver of the echo signal RX, as shown by the arrows 18. The two sensor units 3a, 3b can be arranged on different sides of the vehicle 1. The advantage of this additional operating mode becomes particularly clear when the predetermined movement pattern 6 takes place between the sensor units 3a, 3b. There can be provision for the similarity determination to be applied to the signal characteristics φ(t) of both sensor units 3a, 3b, which are operated in the normal operating mode. Subsequently, the similarity determination can then be applied to the signal characteristic φ(t) of the sensor unit 3b operated as a receiver in the distributed operating mode, in order to be more successful in recognizing a kick as a predetermined movement pattern 6.

FIG. 4a shows a possible signal characteristic φ(t) of a phase, here the phase of the complex channel impulse response that can be recorded when a person takes a step. The normalized signal characteristic φ(t) of the phase of the complex channel impulse response from the time-variable channel impulse response h(t, τ) is shown over a predetermined time period in the time t for the predetermined echo time τP=18 τ0. The characteristic pattern 19 is discernible in the signal characteristic φ(t) with a maximum at approx. t=4 seconds. The characteristic pattern 19 shows a signal characteristic φ(t) of the phase of the complex channel impulse response that is typical for stepping movements. It is thus possible to identify the predetermined movement pattern 6 by detecting the characteristic pattern 19 in the signal characteristic φ(t). The reference characteristic φ0(t) may be predefined for this purpose, this describing the characteristic pattern 19 that causes the predetermined movement pattern 6 in the signal characteristic φ(t). The predetermined movement pattern 6 can now be recognized as a result of the signal characteristic φ(t) meeting a predetermined similarity criterion based on the reference characteristic φ0(t). For this purpose, a similarity between the signal characteristic φ(t) and the reference characteristic φ0(t) can be determined by means of a similarity function. If a predetermined threshold dc of the similarity is exceeded by a similarity value d(t) computed by means of the similarity function, the predetermined movement pattern 6 can be detected. Various algorithms can be used to carry out the comparison method in order to determine the similarity. For example, the “squared Euclidean distance” between points on the signal characteristic φ(t) and points on the reference characteristic φ0(t) can be used. The result of this approach provides information about the similarity of the reference characteristic ϕ0(t) to the recorded signal characteristic ϕ(t). Depending on a speed of the kick, the characteristic pattern 19 can appear in more than one of the channel impulse responses h(τ) recorded at different times t. There can therefore be provision for the signal characteristic φ(t) to need to be generated from the time-variant channel impulse response h(t, τ) for multiple ascertained path delays τP.

FIG. 4b shows a possible signal characteristic φ(t). A pseudo-pattern 20 can be seen in the signal characteristic. The pseudo-pattern 20 may be caused by noise. Depending on the similarity criterion selected and the predefined reference characteristic φ0(t), pseudo-patterns 20 that resemble the characteristic pattern 19 may be identified by the ultra-wideband sensor device 2 as the characteristic pattern 19 of the predetermined movement pattern 6. Because of its similarity, for example, the pseudo-pattern 20 shown in FIG. 4b can be confused with the characteristic pattern 19 shown in FIG. 4a. Since, due to noise in the signal characteristic ϕ(t) of a sensor unit 3, such pseudo-patterns 20 have a certain probability of occurring and cannot be avoided in practice, there is a certain probability, when using a single sensor unit 3, of the ultra-wideband sensor device 2 detecting the predetermined movement pattern 6 erroneously.

FIGS. 5a to 5d show signal characteristics φ(t) that have been recorded from the time-variant channel impulse responses of two sensor units. FIGS. 5a and 5b show the signal characteristics φ(t) of a sensor unit 3a arranged on the left-hand side of the vehicle 1 for the ascertained path delays τP of P=18 τ0 and P=16 τ0. FIGS. 5c and 5d show the signal characteristics φ(t) of a sensor unit 3b arranged on the right-hand side of the vehicle 1 for the ascertained path delays τP of P=18 τ0 and P=16 τ0. At a locality that can be associated with the ascertained path delay τP of P=18 τ0 in the signal characteristics φ(t) of both sensor units 3a, 3b, a kick occurs as the predetermined movement pattern. The characteristic pattern 19, which can be associated with the kick as the predetermined movement pattern 6, can consequently be seen in a period of time 21 in the signal characteristics φ(t) of both sensor units 3a, 3b for the path delay τP of P=18 τ0. There is no movement at a locality that can be associated with the path delay τP of P=16 τ0 in the signal characteristics of both sensor units 3a, 3b. Consequently, the characteristic pattern 19 cannot be seen in the signal characteristics φ(t) for the path delay τP of P=16 τ0. The pseudo-pattern 20 can only be seen in the signal characteristic φ(t) of the left-hand sensor unit 3a. This is not discernible in the signal characteristic φ(t) of the right-hand sensor unit 3b.

FIGS. 5a and 5c reveal that the characteristic pattern 19, which is due to a movement, can be detected in the signal characteristics φ(t) of both sensor units 3a, 3b, while the pseudo-pattern 20 in FIG. 5b statistically can occur in the signal characteristic φ(t) of an individual sensor unit 3a. Since it is unlikely that a pseudo-pattern 20 will be detected by at least two of the sensor units 3 at the same time, erroneous detection of the predetermined movement pattern 6 can be prevented as a result of the predetermined movement pattern 6 having to be detected by at least two of the sensor units 3.

Consequently, the widespread use of two sensor units 3a, 3b in ultra-wideband sensor devices 2 arranged on the left- and right-hand sides of the rear bumper allows the probability of erroneous detection of the predetermined movement pattern 6 to be reduced. This can be achieved by virtue of the pattern 19 needing to be recognized in both sensor units 3a, 3b in the same period of time 21 in the time t and with the same ascertained path delay τP if the predetermined movement pattern is centered on the rear of the vehicle 1 and thus at the same distance from both sensor units 3a, 3b. In the two signal characteristics on the left, the typical pattern 19 of a kick at the same time t and for the same ascertained path delay τP can be clearly seen. As a result, the predetermined movement pattern 6 is detected in this case. No characteristic pattern 19 can be observed in the two signal characteristics φ(t) on the right-hand side; a kind of pseudo-pattern can be observed at least in the signal characteristic of the sensor unit on the left bumper. On the other hand, neither a characteristic pattern 19 nor a pseudo-pattern 20 can be seen in the signal characteristic φ(t) of the right-hand sensor unit 3b. This means that the detection of a kick in the signal characteristic φ(t) of the left-hand sensor unit 3a cannot be confirmed by the signal characteristic φ(t) of the right-hand sensor unit 3b.

FIG. 6 shows signal characteristics φ(t) that have been recorded using the left- and right-hand sensor units 3a, 3b. The signal characteristics ϕ(t) are shown plotted against the time t. The individual columns show the signal characteristics ϕ(t) that have been recorded for respective path delays τ. The path delays τ are proportional to a distance of the movement from the respective sensor unit 3a, 3b. The signal characteristics φ(t) are overlaid with the reference characteristic φ0(t), said reference characteristic having the signal characteristic of a period of an inverted cosine signal or a cosine signal shifted through half a period. This reference characteristic φ0(t) may be associated with a kicking movement as the predetermined movement pattern 6. There can be provision for the kicking movement to be detected when the signal characteristic φ(t) of both sensor units 3a, 3b meets a predetermined similarity criterion with respect to the reference characteristic φ0(t). The similarity criterion can consist, for example, in that a similarity value d(t) computed by means of a similarity function exceeds a predetermined threshold dc. The similarity value d(t) can be computed repeatedly over time or continuously by the ultra-wideband sensor device 2. For the signal characteristics φ0(t) shown, the similarity value d(t) is below the predefined threshold dc, and so the predetermined movement pattern 6 is not detected by any of the sensor units 3a, 3b. The signal characteristics of the similarity values over the time t can be seen in the rows above the signal characteristics. The threshold dc is shown as a horizontal line.

Courtesy of various algorithms, it is possible to obtain information on the similarity of signals or patterns. In a first step, a simplified phase pattern, which is one period of an inverted cosine signal or a cosine signal shifted through half a period, can be used as the reference characteristic ϕ0(t) to continuously compute the similarity of a set of samples of the signal characteristic ϕ(t) of the channel impulse response to this sinusoidal pattern. A predetermined number of measurements (e.g. a window size of 300 measurements) can be used, a similarity of the signal characteristic φ(t) to the reference characteristic φ0(t) over the time t being able to be computed. FIG. 6 shows the starting point of the data stream at a time 0 from the left- and right-hand sensor units 3a, 3b over the path delays τ.

FIG. 7 also shows signal characteristics φ(t) that have been recorded by the two sensor units 3a, 3b. In the signal characteristics φ(t) of the left-hand sensor unit 3a, the respective similarity values d(t) for four path delays τ shown can exceed the predefined threshold dc. The threshold dc is also exceeded for two path delays τ of the right-hand sensor unit 3b, and so the ultra-wideband sensor device 2 detects the predetermined movement pattern 6 for these two path delays τ. The signal characteristics φ(t) in the right-hand sensor unit 3b can be delayed in time compared with the signal characteristics φ0(t) of the left-hand sensor unit 3a. This may be due to the left-hand sensor unit 3a being closer to the moving object 4 than the right-hand sensor unit 3b.

FIG. 8 also shows signal characteristics φ(t) that have been recorded by the two sensor units 3a, 3b. In this figure, it can be seen that a pseudo-pattern 20 similar to the reference characteristic φ0(t) occurs in the signal characteristic φ(t) of one of the path delays τ, and so the similarity value d(t) exceeds the threshold dc. As a result, a movement is detected for the left-hand sensor unit 3a. No pseudo-pattern 20 is detected in the signal characteristic φ(t) of the right-hand sensor unit 3b, and so the threshold dc is not exceeded there. As a result of the threshold dc being exceeded only for one of the sensor units 3a, there can be provision for the ultra-wideband sensor device 2 not to detect the predetermined movement pattern 6.

As already described, the evaluations can be performed for the time-variant channel impulse responses h(t, τ) that describe the echo signals RX received by the respective sensor units 3a, 3b, in order to obtain the respective signal characteristics φ(t). The comparison method can be applied individually to the respective signal characteristics φ(t) of the at least two sensor units 3a, 3b in order to check whether the similarity criterion is met in each case. There can be provision for the predetermined movement pattern 6 to be determined and/or for the control signal 9 to be transmitted only if the similarity criterion in relation to the reference characteristic φ0(t) is met by the at least two signal characteristics φ(t). As a result, the likelihood of incorrect recognition of the predetermined movement pattern 6 can be minimized. Moreover, the use of at least two sensor units 3a, 3b also facilitates the detection of movements outside the center between the two sensor units 3a, 3b. If a movement does not occur exactly in the center between the two sensor units 3a, 3b, but closer to one of the sensor units 3a and further away from the other sensor unit 3b, this can lead to different ascertained path delays τP in the respective channel impulse responses. This makes it possible to classify whether the detected predetermined movement pattern 6 occurred inside or outside the predetermined detection area 11. From the perspective of one application, this makes it possible to configure the ultra-wideband sensor device 2 to transmit the control signal 9 when the predetermined movement pattern 6 is detected in the predetermined detection area 11, in order to initiate an action. At the same time, the ultra-wideband sensor device 2 can be configured not to transmit the control signal 9 if the predetermined movement pattern 6 has occurred outside the predetermined detection area 11. The predetermined detection area 11 in which the predetermined movement pattern 6 is meant to be recognized can also be adjusted dynamically. Multiple predetermined detection areas 11 can also be specified. The predetermined detection areas 11 can have assigned respective predetermined movement patterns 6. Depending on which of the predetermined detection areas 11 the respective predetermined movement pattern 6 is detected in, respective control signals 9 can be transmitted to initiate actions or to activate functions that may be specifically associated with the individual predetermined detection areas 11.

The position of the predetermined detection area 11 can be matched to a detected location 12 of the key carrier 13 using the predetermined specification method. The location 12 can be determined by locating the ultra-wideband key 14, as shown in FIG. 2 for automatic trunk opening. If the key carrier 13 with the ultra-wideband key 14 approaches the vehicle 1 and is authorized to enter the vehicle 1, the predetermined detection area 11 for recognizing the predetermined movement pattern 6 can be adjusted according to the location 12. If the sensor units 3a, 3b are used to communicate with the ultra-wideband key 14 for access in the active mode and at the same time for motion detection in the passive mode, the two functions can be combined.

FIG. 9 shows a mask for combining multiple signal characteristics φ(t). For a movement spanning multiple ascertained phase delays τP, such as a kicking movement for example, the signal characteristics φ(t) of different ascertained path delays τP can also be combined in order to construct a single signal characteristic φ(t) for movement classification. FIG. 10 shows the ascertained path delays τP identified over the time t based on Doppler frequency analyses for a detected kick movement. The kick occurred at a time of t=4 seconds and lasted around 1.5 seconds. First, the path delay τP=20 τ0 was identified for the movement, then the path delay τP=19 τ0 and, at the end of the movement, the ascertained path delay τP=18 τ0. For the ascertained path delay τP=18τ0, the leg and foot that perform the movement, and that are consequently the origin of the echo signal RX, are closest to the sensor unit 3, after which the leg and foot move away from it. The kick thus spans three different ascertained path delays τP.

FIG. 10 shows composite signal characteristics φ(t) formed by applying the mask shown in FIG. 9 to the channel impulse responses for two sensor units 3a, 3b. As can be seen, an impulse occurs in the signal characteristics φ(t) of both sensor units 3a, 3b. This pattern can now be compared with an expected shape predefined by the reference characteristic φ0(t), in order to assess whether or not the applicable predetermined movement pattern 6 is involved. By reducing multiple signal characteristics φ(t) for respective ascertained path delays τP to a single signal characteristic φ(t) per sensor unit 3a, 3b, the computational complexity for the similarity check can be reduced.

Overall, the example shows how the invention can facilitate reliable recognition of predetermined movement patterns by means of an ultra-wideband sensor device.

### LIST OF REFERENCE SIGNS

1 vehicle
2 ultra-wideband sensor device
3 sensor unit
3a left-hand sensor unit
3b right-hand sensor unit
4 object
5 locality
6 predetermined movement pattern
7 pattern
8 control unit
9 control signal
10 trunk
11 detection area
12 location
13 key carrier
14 ultra-wideband key
15 key position
16 lateral displacement
17 arrows
18 arrows
19 characteristic pattern
20 pseudo-pattern
21 period of time
TX impulse radio signal
RX echo signal
ϕ0(t) reference characteristic
ϕ(t) signal characteristic
τ path delay
τP ascertained path delay
dc threshold of the similarity value
d(t) similarity value
h(t) impulse response
h(t, τ) time-variant impulse response
t time

1. A method for recognizing a predetermined movement pattern, comprising:
at an ultra-wideband sensor device:
transmitting impulse radio signals over a predetermined time period,
detecting echo signals of the impulse radio signals by at least one sensor unit of the ultra-wideband sensor device and generating a time-variant channel impulse response that describes the echo signals received by the at least one sensor unit as a function of a time at which the respective impulse radio signal of the predetermined time period was transmitted and a path delay,
ascertaining at least one ascertained path delay using a predetermined selection method,
generating a signal characteristic of the time-variant channel impulse response for the at least one ascertained path delay,
determining a similarity of the signal characteristic to a reference characteristic using a predetermined comparison method, and
if the similarity meets a predetermined similarity criterion, signalling that a predetermined movement pattern associated with the reference characteristic has been detected.

2. The method as claimed in claim 1, further comprising:
at the ultra-wideband sensor device:
detecting the predetermined movement pattern only if the respective signal characteristics of at least two sensor units meet the predetermined similarity criterion.

3. The method as claimed in claim 1,
further comprising:
at the ultra-wideband sensor device:
ascertaining a movement locality of the predetermined movement from the at least one ascertained path delay using a predetermined locating method.

4. The method as claimed in claim 3, further comprising:
at the ultra-wideband sensor device:
transmitting a predetermined control signal if the movement locality of the predetermined movement pattern is situated in a predetermined local detection area.

5. The method as claimed in claim 4, further comprising:
at the ultra-wideband sensor device:
using a predetermined active locating method to detect a key position of an ultra-wideband key, and
specifying the predetermined local detection area based on the key position using a predetermined specification method.

6. The method as claimed in claim 1, wherein the signal characteristic is a phase characteristic of a complex channel impulse response.

7. The method as claimed in claim 4, wherein the predetermined control signal at least one of unlocks and/or opens a trunk of a vehicle.

8. The method as claimed in claim 1, wherein the predetermined comparison method determines the similarity of the signal characteristic to the reference characteristic by computing Euclidean distances between points on the two signal characteristics.

9. An ultra-wideband sensor device for recognizing a predetermined movement pattern, wherein the ultra-wideband sensor device is configured to:
transmit impulse radio signals over a predetermined time period,
detect echo signals of the impulse radio signals by way of at least one sensor unit of the ultra-wideband sensor device and to generate a time-variant channel impulse response that describes the echo signals received by the at least one sensor unit as a function of a time at which the respective impulse radio signal of the predetermined time period was transmitted and a path delay,
ascertain at least one ascertained path delay using a predetermined selection method,
generate a signal characteristic of the time-variant channel impulse response for the at least one ascertained path delay,
determine a similarity of the signal characteristic to a reference characteristic using a predetermined comparison method, and
signal that a predetermined movement pattern associated with the reference characteristic has been detected if the similarity meets a predetermined similarity criterion.

10. A vehicle, comprising an ultra-wideband sensor device for recognizing a predetermined movement pattern as claimed in claim 9.

11. The method as claimed in claim 2, further comprising:
at the ultra-wideband sensor device:
ascertaining a movement locality of the predetermined movement from the at least one ascertained path delay using a predetermined locating method.

12. The method as claimed in claim 11, further comprising:
at the ultra-wideband sensor device:
transmitting a predetermined control signal if the movement locality of the predetermined movement pattern is situated in a predetermined local detection area.

13. The method as claimed in claim 12, further comprising:
at the ultra-wideband sensor device:
using a predetermined active locating method to detect a key position of an ultra-wideband key, and
specifying the predetermined local detection area based on the key position using a predetermined specification method.

14. The method as claimed in claim 11, wherein the signal characteristic is a phase characteristic of a complex channel impulse response.

15. The method as claimed in claim 12, wherein the predetermined control signal at least one of unlocks and opens a trunk of a vehicle.

16. The method as claimed in claim 11, wherein the predetermined comparison method determines the similarity of the signal characteristic to the reference characteristic by computing Euclidean distances between points on the two signal characteristics.
